(19) United States
(12) Patent Application Publication
(10) Pub. No.: US 2026/0061922 A1
(43) Pub. Date: Mar. 5, 2026

(54) DUMP TRAILER HOIST

(71) Applicant: Nordstrong Equipment Limited, Winnipeg (CA)

(72) Inventor: Romain Etienne Guy Coudiere, Winnipeg (CA)

(21) Appl. No.: 18/817,655

(22) Filed: Aug. 28, 2024

(51) Int. Cl. B60P 1/20

(52) U.S. Cl. CPC B60P 1/20

(57) ABSTRACT

An upper weldment includes a first vertical web having a first top edge, a first flange extending horizontally from the first top edge, a second vertical web having a second top edge, and a second flange extending horizontally towards the first flange from the second top edge. The first flange and the second flange are attached. In some cases, the upper weldment is configured to form a three-sided enclosure around a hydraulic cylinder when the hoist is in a closed position. In some cases, the upper weldment and the lower weldment are made of mild steel. A dump trailer hoist includes a main hinge, a lower weldment attached to the main hinge, and the upper weldment described above attached to the main hinge.

### BACKGROUND

Dump trailer hoists typically include a hydraulic cylinder, an upper weldment, and a lower weldment. The upper weldment typically includes a plate with a side flange on either side of the hydraulic cylinder, but are open so that the hydraulic cylinder can fit between the plates when the dump trailer/hydraulic cylinder are in a closed position. However, because the upper weldment requires a plate on each side of the hydraulic cylinder that are not connected, the plates need to be made of hardened steel and/or require additional thickness. Accordingly, there is a need for an upper weldment in a dump trailer hoist that does not require hardened steel and/or uses less or thinner steel.

### BRIEF SUMMARY

An upper weldment includes a first vertical web having a first top edge, a first flange extending horizontally from the first top edge, a second vertical web having a second top edge, and a second flange extending horizontally towards the first flange from the second top edge. The first flange and the second flange are attached.

In some cases, the upper weldment is configured to form a three-sided enclosure around a hydraulic cylinder when the hoist is in a closed position. In some cases, the upper weldment and the lower weldment are made of mild steel.

A dump trailer hoist includes a main hinge, a lower weldment attached to the main hinge, and the upper weldment described above attached to the main hinge.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a dump trailer in an open or dump position.

FIG. 2A illustrates a dump trailer hoist in an open or dump position.

FIG. 2B illustrates a dump trailer hoist in a closed position.

FIG. 2C illustrates an upper weldment of a dump trailer hoist.

### DETAILED DESCRIPTION

An upper weldment for a dump trailer hoist is provided that provides a stronger configuration for lifting a dump trailer, allowing for thinner or less expensive material, such as mild steel, to be used. Furthermore, the upper weldment for the dump trailer hoist provides a three-sided enclosure around a hydraulic cylinder when the hoist is in a closed position, which protects the hydraulic cylinder from unintentional damage.

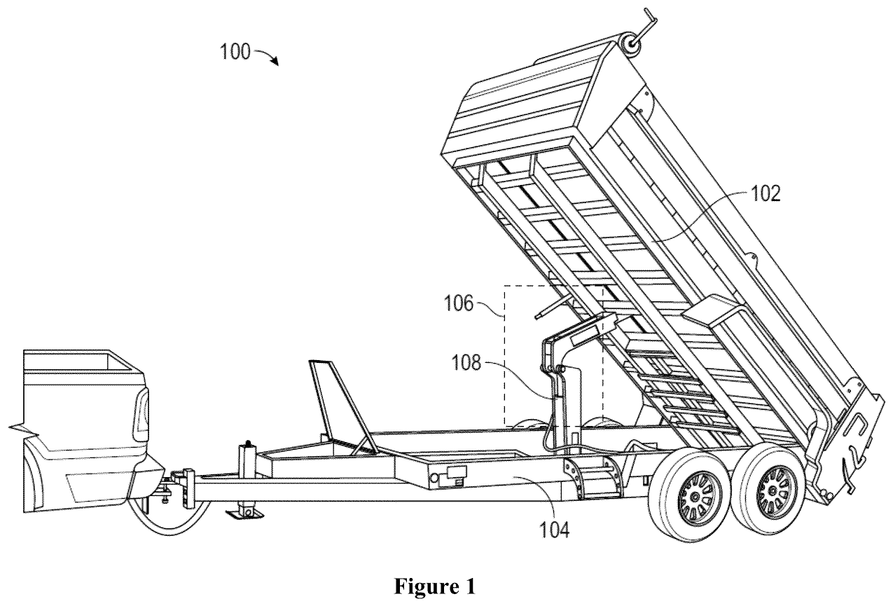

FIG. 1 illustrates a dump trailer in an open or dump position. Referring to FIG. 1, a dump trailer 100 is illustrated with a trailer box 102 in an open or dump position. The open or dump position is where the trailer box 102 is elevated from a trailer frame 104. For example, the trailer box 102 can be in the open or dump position when materials are offloaded from the trailer box 102. Alternatively, a closed position is where the trailer box 102 is positioned atop the trailer frame 104. For example, the trailer box 102 can be in the closed position when the dump trailer 100 is traveling. The trailer box 102 is moved from the closed position to the open or dump position by a dump trailer hoist 106 having a hydraulic cylinder 108. The dump trailer hoist 106 must be strong enough to handle the repetitive nature of moving the trailer box 102 from the closed position to the open position and back each time the dump trailer hoist 106 is used to offload a load of materials in addition to the weight of the trailer box 102 and the load of materials themselves.

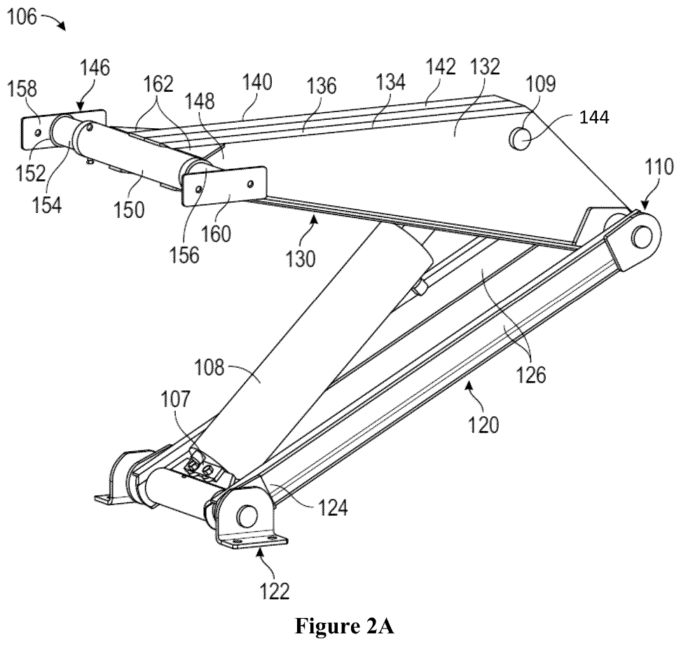

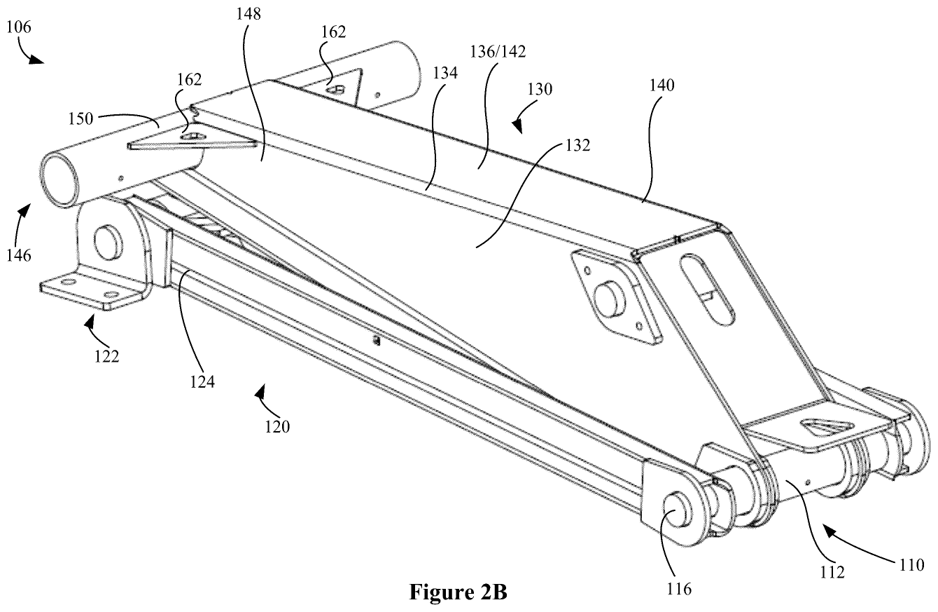

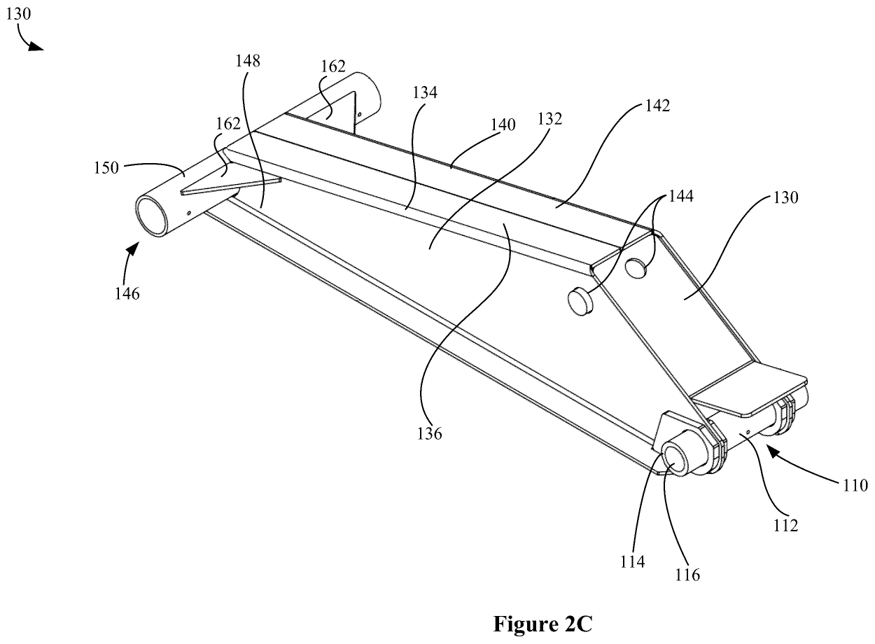

FIG. 2A illustrates a dump trailer hoist in an open or dump position. FIG. 2B illustrates a dump trailer hoist in a closed position. FIG. 2C illustrates an upper weldment of a dump trailer hoist. Referring to FIGS. 2A-2C, a dump trailer hoist 106 includes a main hinge 110, a lower weldment 120 attached to the main hinge 110, and an upper weldment 130 attached to the main hinge 110. The upper weldment 130 includes a first vertical web 132 having a first top edge 134, a first flange 136 extending horizontally from the first top edge 134, a second vertical web that matches the first vertical web 132 on an opposing side of the hydraulic cylinder 108 and having a second top edge 140, and a second flange 142 extending horizontally towards the first flange 136 from the second top edge 140. The first flange 136 and the second flange 142 are attached to one another.

In some cases, the upper weldment 130 forms a three-sided enclosure around a hydraulic cylinder 108 when the hoist 106 is in a closed position. The three-sided enclosure is formed with the first vertical web 132 forming a first vertical side, the second vertical web for a second vertical side that is substantially parallel to the first vertical side, and the first flange 136 and the second flange 142 forming a horizontal side of the three-sided enclosure. In some cases, the first flange 136 and the second flange 142 are monolithic or made of a single plate, as illustrated in FIG. 2B. In some cases, the first flange 136, the second flange 142, the first vertical web 132, and the second vertical web are monolithic or made of a single plate and moulded and/or formed into the three-sided enclosure.

In some cases, the hoist 106 further includes a lower bracket 122 attached to a bottom end 124 of the lower weldment 120. The lower bracket 122 is configured to be attached to a trailer frame, such as the trailer frame 104 of FIG. 1. For example, the lower bracket 122 may be welded to the trailer frame, attached using nuts and bolts, attached using screws, any combination thereof or any other suitable method of securing the lower bracket 122 to the trailer frame known to those skilled in the art.

In some cases, the hoist 106 further includes the hydraulic cylinder 108 coupled to the lower bracket 122 at, proximal to, or near a lower end 107 of the hydraulic cylinder 108 and coupled to the upper weldment 130 at, proximal to, or near an upper end 109 of the hydraulic cylinder 108. In some cases, the first vertical web 132 and the second vertical web each include a hydraulic cylinder pivot aperture 144 for coupling to the hydraulic cylinder 108 via a pin that fits through hydraulic cylinder pivot apertures 144.

In some cases, the hoist 106 further includes an upper bracket 146 attached to a top end 148 of the upper weldment 130. The upper bracket 146 is configured to be attached to a trailer box, such as the trailer box 102 of FIG. 1. In some cases, the upper bracket 146 includes an upper hinge 150, an upper pin 152 coupled through the upper hinge 150. The upper pin 152 includes a first end 154 and a second end 156. The upper bracket 146 may further include a first mounting plate 158 coupled to the first end 154 of the upper pin 152 and a second mounting plate 160 coupled to the second end 156 of the upper pin 152. For example, the upper bracket 146 may be welded to the upper weldment 130, attached using nuts and bolts, attached using screws, any combination thereof or any other suitable method of securing the upper bracket 146 to the trailer frame known to those skilled in the art. In some cases, the upper weldment 130 further includes gussets 162 attached and/or welded to the upper bracket 146, which can be for added strength.

In some cases, the lower weldment 120 includes a set of lower parallel arms 126 attached to the main hinge 110. In some cases, the set of lower parallel arms 126 are spaced such that the hydraulic cylinder 108 can fit between the set of lower parallel arms 126 when the dump trailer hoist 106 is in the closed position. In some cases, the main hinge 110 includes a cylindrical body 112 having a first open end 114 and a second open end opposite of the first open end 114, and a main pin 116 coupled to the cylindrical body 112 through the first open end 114 and the second open end. The main pin 116 is rotatably attached through the cylindrical body 112 and protrudes through the first open end 114 and the second open end.

In some cases, the upper weldment 130 and/or the lower weldment 120 are made of mild steel. The upper weldment 130 and/or the lower weldment 120 can be made of plastics, aluminium alloys, nickel alloys, titanium alloys, composites, hardened steel, stainless steel, any combination thereof or any other suitable materials with similar properties, such as strength, stress, and/or strain, as mild steel.

The upper weldment 130 can include a thickness of between 0.25 inches and 0.375 inches. In some cases, the upper weldment 130 includes a thickness of between 0.125 inches and 0.75 inches. The thickness of the upper weldment 130 can vary depending on the application and weight of the load the dump trailer hoist 100 is rated to offload.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A dump trailer hoist comprising:
a main hinge;
a lower weldment attached to the main hinge; and
an upper weldment attached to the main hinge, the upper weldment comprising:
a first vertical web having a first top edge;
a first flange extending horizontally from the first top edge;
a second vertical web having a second top edge; and
a second flange extending horizontally towards the first flange from the second top edge, wherein the first flange and the second flange are attached.

2. The hoist of claim 1, wherein the upper weldment is configured to form a three-sided enclosure around a hydraulic cylinder when the hoist is in a closed position.

3. The hoist of claim 1, further comprising a lower bracket attached to a bottom end of the lower weldment, the lower bracket configured to be attached to a trailer frame.

4. The hoist of claim 3, further comprising a hydraulic cylinder coupled to the lower bracket at a lower end of the hydraulic cylinder and coupled to the upper weldment at an upper end of the hydraulic cylinder.

5. The hoist of claim 3, further comprising an upper bracket attached to a top end of the upper weldment, the upper bracket configured to be attached to a trailer box.

6. The hoist of claim 5, wherein the upper bracket comprises:
an upper hinge;
an upper pin coupled through the upper hinge, the upper pin comprising a first end and a second end;
a first mounting plate coupled to the first end of the upper pin; and
a second mounting plate coupled to the second end of the upper pin.

7. The hoist of claim 1, wherein the lower weldment comprises a set of lower parallel arms attached to the main hinge.

8. The hoist of claim 1, wherein the main hinge comprises:
a cylindrical body having a first open end and a second open end; and
a main pin coupled to the cylindrical body through the first open end and the second open end.

9. The hoist of claim 1, wherein the first vertical web and the second vertical web each comprise a hydraulic cylinder pivot aperture for coupling to a hydraulic cylinder.

10. The hoist of claim 1, wherein the upper weldment and the lower weldment are made of mild steel.

11. The hoist of claim 1, wherein a thickness of the upper weldment is between 0.125 inches and 0.75 inches.

12. An upper weldment for a dump trailer hoist, comprising:
a first vertical web having a first top edge;
a first flange extending horizontally from the first top edge;
a second vertical web having a second top edge; and
a second flange extending horizontally towards the first flange from the second top edge, wherein the first flange and the second flange are attached.

13. The upper weldment of claim 12, wherein the upper weldment is configured to form a three-sided enclosure around a hydraulic cylinder when the hoist is in a closed position.

14. The upper weldment of claim 12, further comprising an upper bracket attached to a top end of the upper weldment, the upper bracket configured to be attached to a trailer box.

15. The upper weldment of claim 14, wherein the upper bracket comprises:
an upper hinge;
an upper pin coupled through the upper hinge, the upper pin comprising a first end and a second end;
a first mounting plate coupled to the first end of the upper pin; and
a second mounting plate coupled to the second end of the upper pin.

16. The upper weldment of claim 12, wherein the first vertical web and the second vertical web each comprise a hydraulic cylinder pivot aperture for coupling to a hydraulic cylinder.
